(19) United States
(12) Patent Application Publication
(10) Pub. No.: US 2015/0310566 A1
(43) Pub. Date: Oct. 29, 2015

(54) METHOD AND APPARATUS FOR VERIFYING THIRD PARTY EMPLOYEE TIME AND ATTENDENCE

(71) Applicant: Tempbuddy Limited, Dublin (IE)

(72) Inventor: Roderick Smyth, Dublin (IE)

(21) Appl. No.: 14/697,869

(22) Filed: Apr. 28, 2015

Related U.S. Application Data
(60) Provisional application No. 61/985,108, filed on Apr. 28, 2014.

(51) Int. Cl. G06Q 40/00; G06Q 10/10

(52) U.S. Cl. CPC G06Q 40/125; G06Q 10/1091

(57) ABSTRACT

A method and device for using biometric data captured at the time of check-in and check-out by an agency employee worker at a client designated location to verify the identity and location of the worker at the time of check-in/out includes the worker opening an application software on a mobile device and clicking a “Check-In” button in an application display to perform a check-in process defining a biometric capture identifying the worker. The biometric capture includes by a photo, a fingerprint, a retinal scan, or a worker DNA upon arriving at a work location. The worker accepts the captured data from the first check-in stage as accurate. The worker performs a check-out process at a worker finish time including in a first finish stage opening the application software and clicking a “Check Out” button in the display. In a second finish stage the biometric capture identifying the worker is repeated.

### CROSS-REFERENCE TO RELATED APPLICATIONS

This application claims the benefit of United States Provisional Application Serial No. 61/985,108 filed on Apr. 28, 2014. The entire disclosure of the above application is incorporated herein by reference.

### FIELD OF THE INVENTION

This invention relates to a method and apparatus for verifying an agency or third party worker's time and attendance using a mobile device with geolocation or GPS features and coupling this with biometric data capture at the time of check in.

### BACKGROUND OF THE INVENTION

This section provides background information related to the present disclosure which is not necessarily prior art.

In the staffing industry, third party employees working from customer sites currently complete historical time cards of their prior working week and present this to a designated manager (or approver). The manager then confirms the details presented to them and the worker faxes or sends the signed document to the agency which is then used to process payroll and invoicing information. With this method, there is no absolute evidence that the worker in question was present at the stated time. In current systems, the manager is required to recall and verify the start and end time for a worker and resolve any disputes based on their recall. This is compounded in industries where the manager is not present at the place of work, or where multiple places of work are required for a worker to perform his/her duties.

In many cases the designated approver is not present at the work location or at the start time to verify the attendance on the worker.

In many cases the designated approver is not present or not available to approve timesheets once a working period (whether daily, weekly or other) is complete. This give rise to delays in processing the pay of the worker and payment to the staffing agency.

### SUMMARY OF THE INVENTION

According to the present invention, technology is used to pinpoint the location of a worker and in the same transaction capture biometric information data before submitting this to a staffing agency central platform for processing, verification and later collation & reporting.

The worker receives notification from the staffing agency on a mobile device (smartphone, portable or wearable) of an upcoming assignment as well as information on the work location, start and finish times and other relevant and useful information. Upon arriving to the work location, the worker uses the mobile device to open application software “App” and clicks the “Check In” (or appropriately named button) in the App. This action triggers the capture process and launches the confirmation stage of the check-in process. The second stage could be any biometric capture method including photo, fingerprint, retinal scan, DNA or other sampling method which may or may not require additional hardware or licensing. The worker accepts the captured data as accurate which is then combined with the location, time and worker information to be submitted to the central server. This is submitted immediately where a connection is available or, if one is not available, stored and re-attempted later once a connection becomes available. In the alternative, the biometric data capture can be the first step followed by check-in confirmation by the worker as the second step.

At the end of a reporting period the verified report is presented to the client approver and/or the staffing agency approver with the inclusion of biometric evidence based validation of the worker's presence at the time and location stated on the report.

### DESCRIPTION OF THE DRAWINGS

The above as well as other advantages of the present invention will become readily apparent to those skilled in the art from the following detailed description of a preferred embodiment when considered in the light of the accompanying drawings in which:

FIG. 1 is a schematic flow diagram of the method for verifying an agency or third party worker's time and attendance according to the invention;

FIG. 2 is a schematic view of alternative check-in and confirmation processes during performance of the method illustrated in FIG. 1; and

FIG. 3 is a schematic block diagram of an apparatus used to perform the method illustrated in FIG. 1.

### DETAILED DESCRIPTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

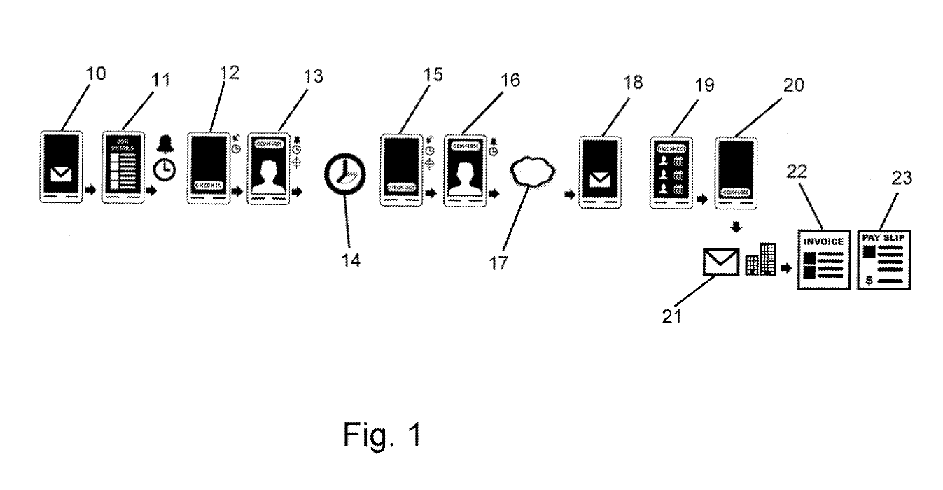

FIG. 1 illustrates the method for verifying to a staffing agency a third party employee's or worker's time and attendance according to the invention. In a first stage or step 10, a third party employee or worker receives notification from a staffing agency on his/her mobile device (smartphone, portable or wearable; tablet computer; laptop computer; netbook computer; ultra-light portable computer; or the like) of an upcoming assignment. In a next step 11, information (Job Details) included with the notification stating the customer work location, start and finish times and other relevant and useful information is displayed to the worker. Upon arriving to the work location, the worker performs check-in process by performing a first stage or step 12 by opening the App (application software according to the invention) and clicking the “Check In” (or appropriately named button) in the App display. This action triggers a capture process and launches a second stage or confirmation stage of the check-in process. The second stage could be any biometric capture method step 13 to identify the worker, including but not limited to a photo, fingerprint, retinal scan, Worker DNA or other sampling method. The worker reviews and accepts the captured data as accurate which is then combined with a worker location, a worker start time and worker information to be submitted to a staffing agency central server or a cloud computing service. This is submitted immediately where a connection is available or, if one is not available, the information is stored and re-attempted later once a connection becomes available. An alternative two step check-in and confirmation process can also be used as described in greater detail below.

At a worker finish time 14, the worker performs a check-out process including a first finish stage or step 15 by opening the App and clicking a “Check Out” (or appropriately named button) in the App display. This action again triggers the capture process and launches a confirmation stage of the check-out process. A second stage or step of the check-out process includes a biometric capture method step 16 similar to capture method step 13 which again identifies the worker including a photo, a fingerprint, a retinal scan, worker DNA, or other sampling method. The worker reviews and accepts the captured data as accurate (or corrects any necessary data) which is then combined with the location, the job finish time and worker information to be submitted to the staffing agency central server or the cloud computing service. The check-out process information is submitted immediately where a connection is available or, if one is not available, the information is stored and re-submitted later once a connection becomes available.

The submission of each of the check-in process and the check-out process information to the central server or the cloud service is by any suitable transmission process such as an Internet connection 17, a mobile phone connection, or a telephone land line connection.

The central server or cloud service generates a time sheet for the worker from the submitted check-in and check-out proves information. The time sheet is transmitted to the worker's mobile device in a step 18 and displayed to the worker in a step 19. The worker then reviews and verifies the report or time sheet to the central server or the cloud service the accuracy of the time sheet as a verified report in a step 20. This can be done via any suitable means such as the mobile device, an email service, or a website portal. At the end of a reporting period the verified report is presented to the staffing agency approver in a step 21 with the inclusion of the biometric evidence based validation of the worker's presence at the time and location stated on the report. Upon approval of the verified report by the approver, an invoice to the customer is generated in a step 22 and a pay slip for the worker is generated in a step 23.

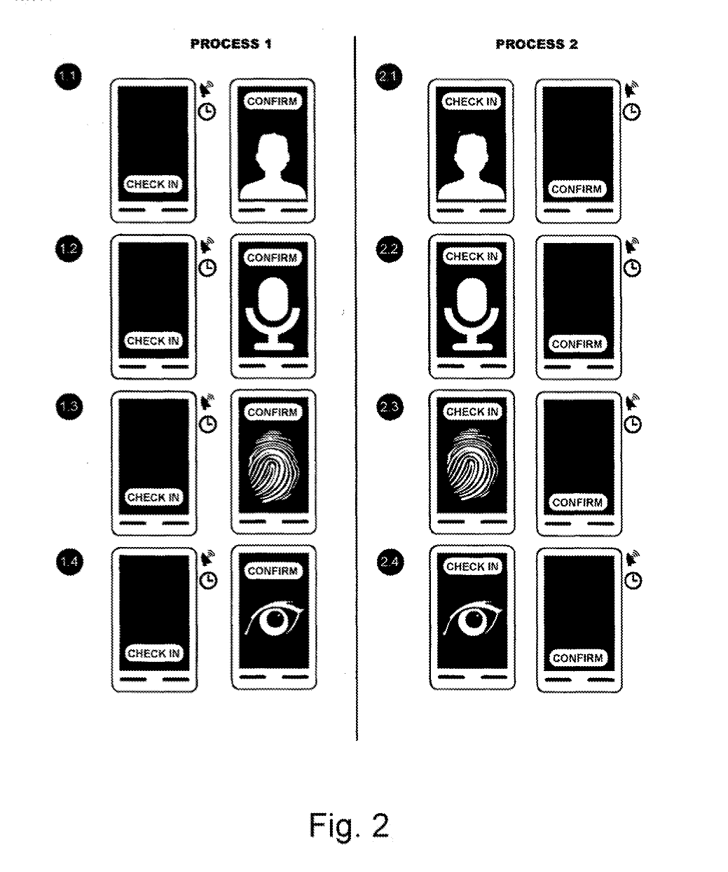

FIG. 2 shows alternative two stage check-in and data capture processes using a mobile device with a camera and GPS features. In a Process 1, the first stage is a check-in that triggers a biometric data capture and the second stage is a confirmation of the biometric data by the worker. In a Process 2, the first stage is the capture of the biometric data and the second stage is the check-in confirmation by the worker. The biometric data can be a facial profile that is then compared with a verified profile photo using Computer Visualization techniques on the platform at the central server. This comparison takes place at a central location for several reasons including: security over original biometric data; allowing multiple biometric checks against a single profile; ensuring that the biometric data is that of the registered employee and not just a verification of which profile is stored on a particular device; and allowance of the use of multiple different capture devices to submit check-in/out data. Biometric capture methods include: the facial recognition (1.1, 2.1), voice recognition (1.2, 2.2), fingerprint recognition (1.3, 2.3), retinal scan recognition (1.4, 2.4), handwriting recognition, DNA recognition, or other hardware or software based biometric identifiers. The worker reviews and accepts the captured data as accurate which is then combined by software of the mobile App with the location, finish time and worker information to be submitted to the central server.

A proper understanding of the method according to the invention is essential to workers and by providing a two-stage or two-step process this is efficient and clear to the user of the mobile App. The two-stage or two-step process also informs the worker that the data he/she is about to submit contains verifiable information and encourages respectful use of the process. The specific order of the process is not essential to the process and the method also covers a process that starts with biometric capture followed by check-in confirmation or a check-in followed by biometric capture. A technical problem solved by the present method is to provide biometric confirmation of a worker/user information both at an initial check-in process or stage and to reconfirm this information at a check-out process or stage, thereby providing verification of worker/user presence at a job site at both the start and finish of a job, together with data necessary to complete a time sheet and record verification data for billing and timesheet creation.

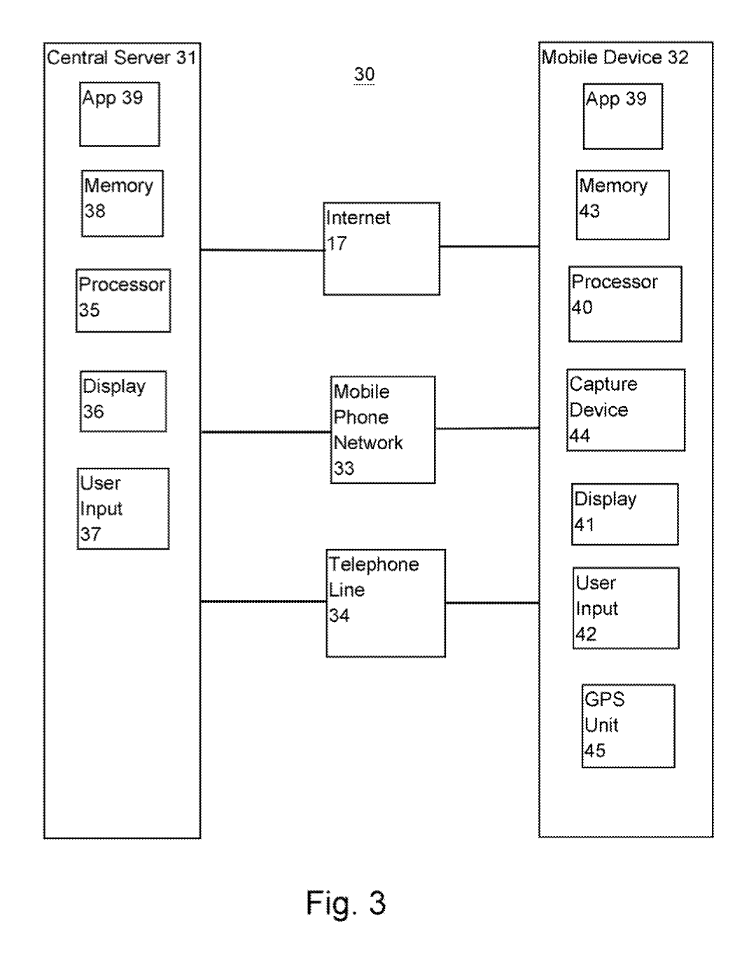

Referring to FIG. 3, an apparatus 30 for performing the method described above is shown. A staffing agency central server 31 is in communication with a mobile device 32 of the worker through one or more communication channels such as the Internet 17, a mobile phone network 33, or a telephone land line 34. The central server 31 includes a processor 35 for running software programs, a display 36 for presenting information to a user such as the approver mentioned above, and a user input 37 for entering information and commands. The display 36 and the user input 37 may be optional. The central server 31 also includes a memory 38 for storing the software programs and data related to various workers. An App 39 for performing the method according to the invention is stored in the central server 31 separately or in the memory 38. As explained above, a cloud service is an alternative to the central server 31.

The central server 31 downloads the App 39 through one of the communication channels 17, 33, 34 to the mobile device 32. The App 39 also could be available from an app website (Apple iTunes store or Google Play) or the cloud service. The mobile device 32 includes a processor 40 for running software programs, a display 41 for presenting information to the worker, and a user input 42 for entering information and commands. The mobile device 32 also includes a memory 43 for storing the software programs and data. The App 39 for performing the method according to the invention is stored in the mobile device separately or in the memory 43. The mobile device 32 further includes a Biometric capture device 44 such as a camera and a microphone. Location information is provided by a GPS unit 45 in the mobile device 32.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A method for using biometric data captured at the time of check-in and check-out by an agency employee worker at a client designated location to verify the identity and location of the worker at the time of check-in/out, the method comprising the steps of:
the worker opening an application software on a mobile device and clicking a “Check-In” button in an display on the mobile device generated by the application software to perform a check-in process defining a biometric capture identifying the worker, including by a photo, a fingerprint, a retinal scan, or a worker DNA upon arriving at a work location;
the worker accepting captured data from the first check-in process as accurate;
the worker performing a check-out process at a worker finish time including in a first finish stage opening the application software and clicking a “Check Out” button in the application software display; and
in a second finish stage repeating the biometric capture identifying the worker.

2. The method according to claim 1, further comprising combining the captured data from the check-in process with a worker location, a worker start time and worker information for submission to a staffing agency.

3. The method according to claim 1, further comprising combining the captured data from the second finish stage with the worker location, a job finish time and the worker information for submission to the staffing agency.

4. The method according to claim 1, further comprising:
the worker receiving in a notification step from a staffing agency on the mobile device of an upcoming job assignment; and
displaying information of job details included with the notification stating at least a customer work location and start and finish times to the worker on the mobile device.

5. The method according to claim 1, further comprising the worker accepting captured data from the second finish stage as accurate prior to combining the captured data with the worker location, a job finish time and the worker information for submission to the staffing agency.

6. A method for geolocation check-in of an agency worker on a mobile device, the method comprising steps of:
the worker receiving in a first step a notification from a staffing agency on a mobile device of an upcoming job assignment;
displaying in a second step information of job details included with the notification stating at least a customer work location and start and finish times to the worker on the mobile device;
the worker performing check-in process including a first check-in stage upon arriving at a work location by opening an application software on the mobile device and clicking a “Check In” button in a display generated by the application software on the mobile device;
launching a second check-in stage defining a biometric capture step identifying the worker, including by a photo, a fingerprint, a retinal scan, or a worker DNA;
the worker accepting captured data from the second check-in stage as accurate which is then combined with a worker location, a worker start time and worker information for submission to the staffing agency;
the worker performing a check-out process at a worker finish time including in a first finish stage opening the application software and clicking a “Check Out” button in the application software display;
repeating in a second finish stage the biometric capture step identifying the worker, including by a photo, a fingerprint, a retinal scan, or a worker DNA; and
the worker accepting captured data from the second finish stage as accurate which is then combined with the worker location, a job finish time and the worker information for submission to the staffing agency.

7. The method according to claim 6, further comprising submitting the captured data from each of the launching step combined with the worker location, the worker start time, and the second finish stage combined with the worker location, the job finish time and the worker information immediately when a connection is available.

8. The method according to claim 7, further comprising performing the submitting step using an Internet connection.

9. The method according to claim 7, further comprising performing the submitting step using a mobile phone connection.

10. The method according to claim 7, further comprising performing the submitting step using a telephone land line connection.

11. The method according to claim 7, further comprising:
generating a time sheet for the worker from the submitted information;
transmitting the time sheet to the worker's mobile device and displaying the time sheet to the worker; and
the worker confirming to the staffing agency the accuracy of the time sheet.

12. The method according to claim 11, further comprising:
presenting the worker confirmed time sheet to a staffing agency approver with the biometric capture method step based validation of the worker's presence at the time and location identified on the time sheet; and
generating an invoice to a customer and a pay slip for the worker.

13. The method according to claim 6, further comprising storing the captured data from each of the launching step combined with the worker location, the worker start time, and the second finish stage combined with the worker location, the job finish time and the worker information for later submission when a connection is available.

14. A method for geolocation check-in of an agency worker on a mobile device, the method comprising the steps of:
the worker receiving in a first step a notification from a staffing agency on a mobile device of an upcoming job assignment;
displaying in a second step, information of job details included with the notification stating at least a customer work location and start and finish times to the worker on the mobile device;
the worker performing a first check-in stage defining a biometric capture method step identifying the worker, including by a photo, a fingerprint, a retinal scan, or a worker DNA upon arriving at a work location;
the worker accepting captured data from the first check-in stage as accurate;
the worker launching a second check-in stage by opening an application software on the mobile device and clicking a “Check In” button in an application display generated by the application software on the mobile device, the captured data then combined with a worker location, a worker start time and worker information for submission to the staffing agency;
the worker performing a check-out process at a worker finish time including in a first finish stage opening the application software and clicking a “Check Out” button in the application display;
repeating in a second finish stage the biometric capture step identifying the worker, including by a photo, a fingerprint, a retinal scan, or a worker DNA; and
the worker accepting captured data from the second finish stage as accurate which is then combined with the worker location, a job finish time and the worker information for submission to the staffing agency.

15. A device for geolocation check-in and check-out of an agency employee worker at a client location comprising:
a mobile device running an application software performing a two-step check-in and confirm process which captures biometric and location data of the worker in a single process for sending verifiable data;
a central server or cloud service responsive to the data verifying the data and generating an invoice to the worker and to a client;
a pay slip for the worker generated from the verified data; and
a communication channel operating to transfer information including the verified data between the mobile device and the central server or the cloud service.

16. The device according to claim 15, further including a second check-in stage wherein the worker launches the second check-in stage by opening the application software provided on the mobile device and clicking a “Check In” button in an application display generated by the application software, the application software combining the captured data with a worker location, a worker start time and worker information for submission to the staffing agency.

17. The device according to claim 15, wherein a display of the mobile device operates to display information of job details included with the notification stating at least a customer work location and start and finish times to the worker.

18. The device according to claim 15, wherein a display of the mobile device operates using the application software to allow the worker to accept captured data from a finish stage as accurate prior to combining with the worker location, a job finish time and the worker information for submission to the staffing agency.

19. The device according to claim 15, wherein the mobile device includes:
a memory for storing software programs and data, the application software being stored in the mobile device in the memory; and
a biometric capture device including a camera and a microphone.

20. The device according to claim 15, further including a GPS unit in the mobile device, wherein worker location information is provided by the GPS unit in the mobile device.
